(19) United States
(12) Patent Application Publication
(10) Pub. No.: US 2005/0169727 A1
(43) Pub. Date: Aug. 4, 2005

(54) Fastener component

(76) Inventor: Frank J. Cosenza, Santa Barbara, CA (US)

Correspondence Address: Brij K. Agarwal;Eckert Seamans Cherin & Mellott, LLC, 44th Floor, 600 Grant Street, Pittsburgh, PA, 15219, US

(21) Appl. No.: 10/770,318

(22) Filed: Feb. 2, 2004

(51) Int. Cl. F16B 39/10

(52) U.S. Cl. 411/120

(57) ABSTRACT

An improved fastener component is mountable to a structure and is cooperable with a male threaded fastener component to permit a panel to be mounted to the structure. The improved fastener component includes a first piece mountable within a hole formed in the structure and a second piece movably disposed on the first piece. The first piece includes an elastically-deflectable support and a pair of latches disposed on the support. The second piece includes a female threaded nut and a pair of tabs that extend outwardly in opposed directions from the nut. The tabs are movably disposed in windows formed in the first piece. The first piece mounted to the structure permits the second piece to be movable within a plane yet resists movement of the second piece away from the plane.

### BACKGROUND OF THE INVENTION

1. Field of the Invention

The present invention relates generally to fasteners and, more particularly, to a fastener component that is mountable to a hole formed in a structure and is cooperable with a screw to permit the mounting of a panel to the structure.

2. Description of the Related Art

In various applications, such as aerospace and other applications, it is often necessary to employ a relatively large number of fasteners when mounting together relatively large structures. For instance, flooring surfaces of airplanes are provided by honeycomb composite panels that are secured with large numbers of fasteners to bracing members that carry the panels. In such an exemplary situation, a large number of regularly spaced holes are formed in the bracing member, and a corresponding set of holes are formed in the panel. Fasteners are received through the holes in the bracing member and the panel to fasten the two together.

If the fasteners being employed are threaded fasteners, such as fasteners having a female threaded component and a male threaded component, the female threaded fastener components may be mounted to the bracing member in the vicinity of each hole. Cooperative male threaded fastener components may then be received through the holes formed in the bracing member and panel and be threadably cooperated with the female threaded fastener components in order to fasten the panel and the bracing member together. While fasteners employed for such a purpose have been generally useful for their intended purposes, such fasteners have not, however, been without limitation.

It is known that when large numbers of spaced holes are formed in a single member, imprecision in measurement and limitations with cutting tools oftentimes result in the holes being slightly misplaced from where they should be. Such slight placement errors typically are acceptable in many applications. However, in applications where large numbers of spaced holes are formed, slight misplacements of holes can accumulate such that the cumulative misplacement across the length of a member can result in the holes of, for instance, the bracing member being significantly misaligned with what should be corresponding holes in the panel. It thus has been known to make the holes in the bracing member relatively larger and to provide female threaded fastener components that are slightly adjustable in order to compensate for cumulative misalignment of holes in either or both of the bracing member and the panel. While such movable fastener components have been largely effective for their intended purpose, such fastener components have not, however, been without limitation.

Such female threaded fastener components often have been movable in a plane that is transverse to the longitudinal extent of a male threaded fastener component (which movability is desirable) as well as in an axial direction generally along the longitudinal extent of the male threaded fastener (which is generally undesirable). If, when attempting to install and cooperatively thread a male threaded component with a female threaded component, the female threaded component moves axially away from the male threaded component, cooperative threading will be difficult to achieve. Oftentimes relatively long male threaded fastener components have been required in order to probe within the holes to locate the precise position of the female threaded fastener component. Such threading effort is both tedious and results in unneeded excess weight due to the excess length of the male threaded fastener components.

It thus would be desirable to provide an improved fastener component that overcomes these and other shortcomings of known fastener components. Such an improved fastener component may be mountable to a structure such as a bracing member, and also may include a female threaded portion or other fastenably cooperable component that is movable within a given plane but that is substantially immovable in directions away from the given plane.

### SUMMARY OF THE INVENTION

An improved fastener component in accordance with the present invention advantageously meets these and other needs. An improved fastener component is mountable to a structure and is cooperable with a male threaded fastener component to permit a panel to be mounted to the structure. The improved fastener component includes the first piece and a second piece, with the first piece being mountable within a hole formed in the structure, and with the second piece being movably disposed on the first piece. The first piece includes an elastically-deflectable support and a pair of latches disposed on the support. The elastic delectability of the support permits the latches to be elastically deflected toward one another and to be biased into engagement with opposed portions of a hole formed in the structure. The second piece includes a female threaded nut and a pair of tabs that extend outwardly in opposed directions from the nut. The tabs are movably disposed in windows formed in the first piece. The first piece mounted to the structure permits the second piece to be movable within a plane yet resists movement of the second piece away from the plane.

An aspect of the present invention is to provide an improved fastener component that includes a pair of latches that are mountable within a hole formed in a structure to retain the fastener component on the structure.

Another aspect of the present invention is to provide an improved fastener component having a first piece that is mountable on a structure and a second piece that is mounted to the first piece and is movable in a plane with respect to the structure, with movement of the second piece away from the plane being resisted.

Another aspect of the present invention is to provide an improved fastener component that is mountable to a structure and accommodates cumulative misplacement among a plurality of spaced holes formed in the structure or another structure being attached thereto.

Another aspect of the present invention is to provide an improved fastener component having a first piece and a second piece, the second piece being movably disposed on the first piece, the first piece including a pair of latches disposed on a support, with each latch including a leg and a lip, the legs being structured to extend through a hole formed in a structure, the lips being structured to be engagable with a first surface of the structure, the support and the second piece being disposed at a second, opposite surface of the structure, the lips being structured to resist unintended movement of the second piece away from the structure.

Another aspect of the invention is to provide an improved fastener component having a first piece and a second piece, the first piece being elastically deflectable, the second piece being movably disposed on the first piece in order to accommodate such elastic deflection of the first piece and to permit movement of the second piece when the first piece is in an elastically deflected condition.

Accordingly, an aspect of the present invention is to provide an improved fastener component of the type that is structured to be mounted to a structure having an opening formed therein, the structure having a structure surface, the opening extending into the structure adjacent the structure surface, in which the general nature of the fastener component can be stated as including a first piece and a second piece. The first piece has a support and a pair of latches, with the latches being disposed on the support. The first piece also has a pair of windows formed therein. The support is elastically deflectable, whereby the latches are elastically deflectable generally toward one another. The second piece has a nut and a pair of tabs, with the tabs protruding outwardly from the nut. The tabs extend through the windows and are movably disposed therein. Each latch has a leg and a lip, with the legs extending generally away from the support and being structured to extend through the opening formed in the structure, and with the lips protruding from the legs and being structured to be engageable with the structure surface to resist unintended movement of the nut away from the structure.

### BRIEF DESCRIPTION OF THE DRAWINGS

A further understanding of the invention can be gained from the following Description of the Preferred Embodiment when read in conjunction with the accompanying drawings in which:

FIG. 1 is a perspective view of an improved fastener component in accordance with the present invention;

FIG. 2 is a perspective view of the fastener component in an exploded condition;

FIG. 3 is a perspective view of the fastener component in an elastically deflected condition;

FIG. 4 is a perspective view of the fastener component mounted to a structure;

FIG. 5 is a sectional view as taken along the line 5-5 of FIG. 4 and with the structure of FIG. 4 removed; and

FIG. 6 is a view similar to FIG. 5, except depicting the structure of FIG. 4 and additionally depicting a screw and a panel mounted to the fastener component and to the structure.

Similar numerals refer to similar parts throughout the specification.

### DESCRIPTION OF THE PREFERRED EMBODIMENT

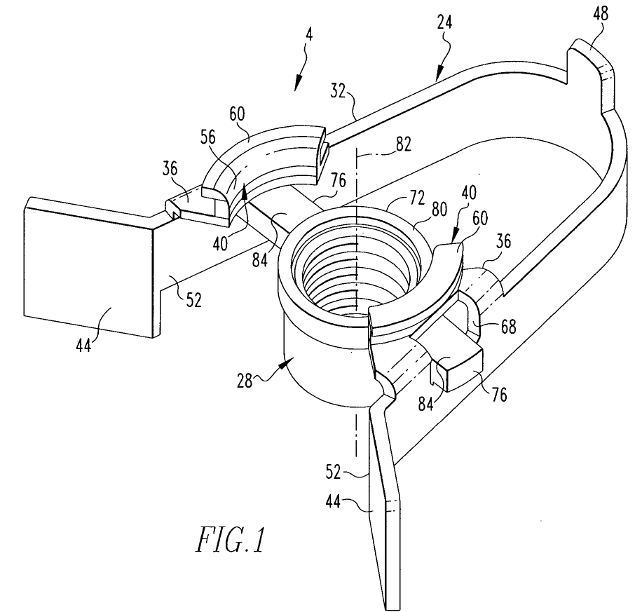

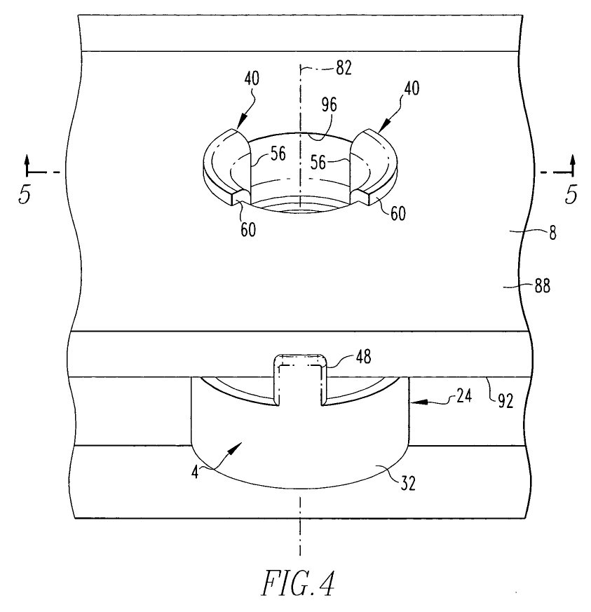

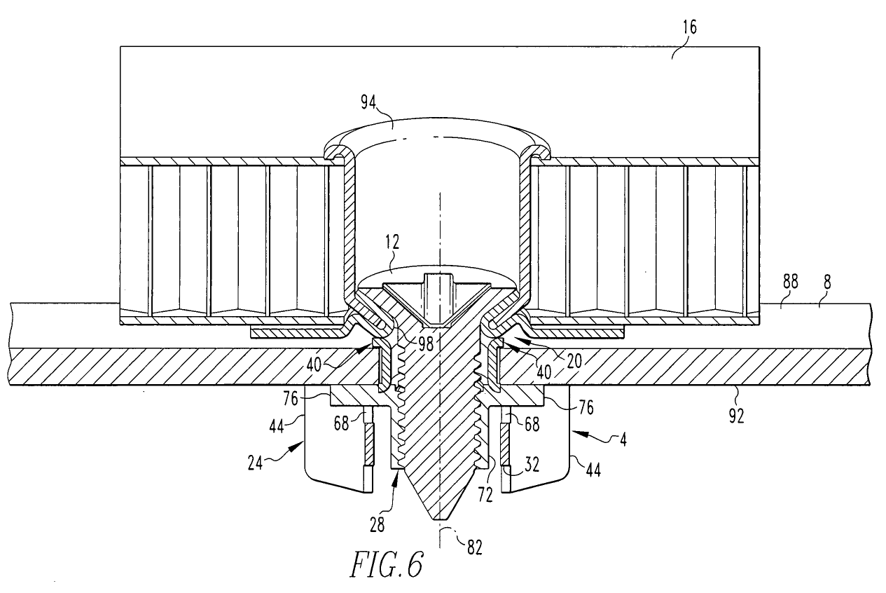

An improved fastener component 4 in accordance with the present invention as indicated generally in FIGS. 1-6. The fastener component 4 is mountable to a structure 8 (FIGS. 4 and 6) and is cooperable with a cooperative fastener component such as a screw 12 (FIG. 6) to permit another component such as a panel 16 (FIG. 6) to be attached to the fastener component 4 and to the structure 8. When cooperated together, the fastener component 4 and the screw 12 can be understood to constitute a fastener 20 that is employed to connect together the structure 8 and the panel 16. While the exemplary fastener component 4 and screw 12 are described herein as being threadably cooperable with one another or otherwise as being of a threadable nature, it is understood that the fastener component 4 and the screw 12 could be of other non-threaded fastenable configurations, such as those employing bayonet fittings or employing any of a variety of other attachment methodologies without departing from the concept of the present invention.

The fastener component 4 can be generally described as including a first piece 24 and a second piece 28. The second piece 28 is movably disposed on the first piece 24 and, as will be set forth in greater detail below, is configured to permit members such as the structure 8 and the panel 16 to be connected together despite possible cumulative misplacement of holes in either or both.

The first piece 24 includes a support 32, a pair of platforms 36, a pair of latches 40, a pair of wings 44, and an anti-rotation protrusion 48. The support 32 is a generally U-shaped member that is elastically deflectable and includes a pair of free ends 52. The elastically deflectable nature of the support 32 permits the free ends 52 to be elastically deflected generally toward one another. The support 32 could be configured to be of shapes other than generally U-shaped without departing from the concept of the present invention.

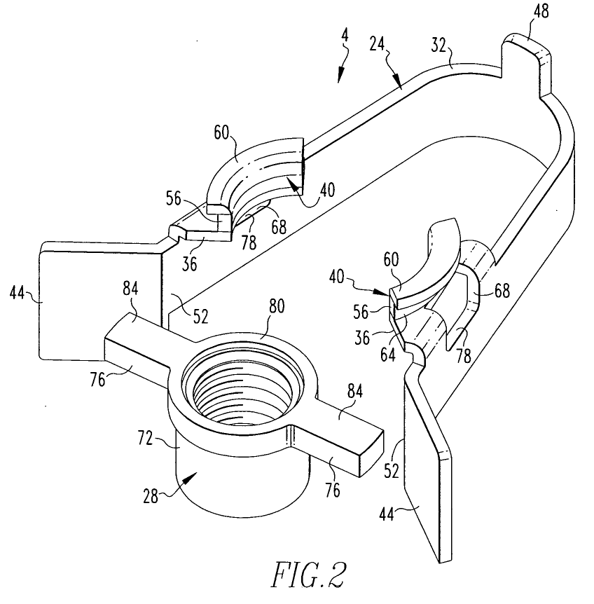

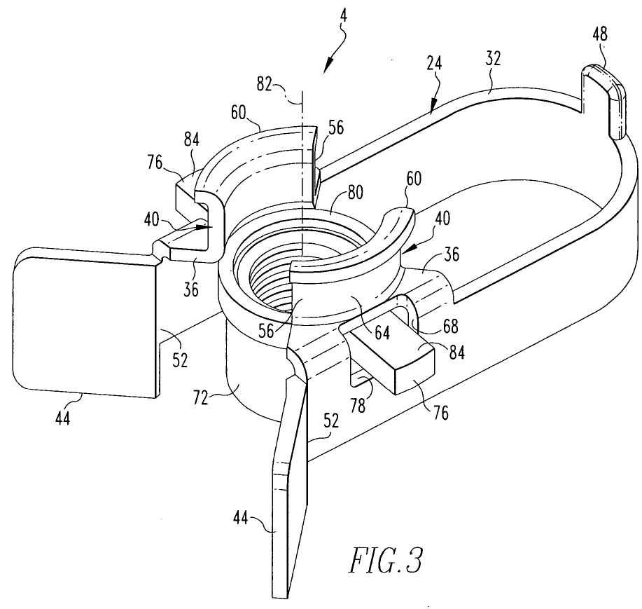

The wings 44 are angled members that are disposed at the free ends 52 of the support 32 and are oriented generally oblique to the support 32 at the free end 52. The wings 44 can be manually gripped in order to elastically deflect the support 32 between a free state, such as is depicted generally in FIGS. 1 and 2, and a deflected state, such as is depicted generally in FIGS. 3-6, it being understood that the support 32 can be elastically deflected to an even greater extent than is expressly depicted herein.

The platforms 36 are disposed on the support 32 adjacent the free ends 52. The platforms 36 extend from the support 32 generally toward one another from the free ends 52. The latches 40 are disposed on the platforms 36 and extend from the platforms 36 in a direction generally away from the support 32. In the exemplary embodiment depicted herein, the platforms 36 extend generally within a plane from the support 32, and the latches 40 extend from the portions of the platforms 36 opposite the support 32 in a direction generally perpendicular to such plane.

Each latch 40 includes a leg 56 and a lip 60. For each latch 40, a first end of the leg 56 is disposed on one of the platforms 36, and the corresponding lip 60 is disposed at a second, opposite end of the leg 56. The lips 60 are thus disposed on the legs 56 opposite the platforms 36 and opposite the support 32. In the depicted exemplary embodiment, the lips 60 extend from the legs 56 generally within a plane and generally away from one another.

The anti-rotation protrusion 48 is, in the depicted example, disposed on the support generally between the free ends 52. The anti-rotation protrusion 48 and the latches 40 extend in a common direction away from the support 32, and more specifically in the present example they extend generally parallel with one another in the same direction away from the support 32.

The first piece 24 includes a pair of windows 68 formed therein in the vicinity of the platforms 36 and the latches 40. As employed herein, the expression “in the vicinity of” and variations thereof shall refer broadly to relatively proximal positioning that can include positioning adjacent, within, and/or nearby. In the depicted example, the windows 68 are formed to extend partially into the support 32 and partially into the platforms 36. In other embodiments not depicted, the windows could additionally or alternatively extend at least partially into the latches 40, and additionally or alternatively can be configured not to extend into either or both of the support 32 and the platforms 36.

The first piece 24 can be of numerous configurations and can be manufactured in a variety of ways. In one exemplary embodiment, the first piece 24 is formed out of an aluminum alloy and is a monolithically formed single piece member that is substantially free of joints, and can be formed from a sheet of material such by stamping, although other materials, configurations, and formation methodologies may be employed without departing from the concept of the present invention.

Each leg 56 includes an engagement surface 64 (FIGS. 2 and 3) which, in the depicted example, is arcuate. The engagement surfaces 64 of the two latches 40 face generally away from one another. When the support 32 is in an elastically deflected condition, the support 32 biases the engagement surfaces 64 generally away from one another.

The second piece 28 includes a nut 72 and a pair of tabs 76. The nut 72 includes female threading that is threadably cooperable with the screw 12 but, as indicated above, the nut 72 could be of other configurations fastenably cooperable with another component to form the fastener 20.

The tabs 76 extend radially outwardly from the nut 72 in diametrically opposed directions. When the first piece 24 is in its free state, the tabs 76 extend through the windows 68 and are movably disposed therein. The tabs 76 likewise extend through the windows 68 and are movably disposed therein when the first piece 24 is in an elastically deflected condition, such as is depicted generally in FIGS. 3-5.

The windows 68 are relatively larger than the cross-sectional size of the tabs 76 to permit movement of the tabs 76 and thus of the second piece 28 within a plane that is at least partially defined by a pair of window surfaces 78 formed on the first piece 24 and each defining a side of one of the windows 68. The windows 68 advantageously permit movement of the second piece 28 within a plane, yet resist movement of the second piece 28 away from the plane. More specifically, the second piece 28 is permitted to move within a plane that is perpendicular to a nut axis 82 that is coaxial with the female threads on the nut 72 and is parallel with the longitudinal extent of the screw 12, yet movement away from such plane is resisted by the first piece 24.

The nut 72 includes a substantially annular and planar nut surface 80 extending about the outer periphery of the nut 72. The tabs 76 each include a tab surface 84 that is substantially planar. In the depicted example, the nut surface 80 and the tab surfaces 84 are substantially coplanar. In the depicted example the nut surface 80 and the tab surfaces 84 are also contiguous, meaning that each of these surfaces contacts another of the surfaces.

The second piece 28 can be made of a wide variety of materials but, in the present example, is made of a material that is compatible with the first piece 24 and the screw 12, and accordingly may be formed out of an aluminum alloy or other appropriate material. The second piece 28 in the depicted embodiment is a monolithically formed single-piece member that is substantially free of joints, and it may be formed by stamping, although other configurations and formation methodologies may be employed without departing from the concept of the present invention.

The fastener component 4 is mountable to a hole, such as an opening 96 formed in the structure 8. The structure 8 is, in the depicted example, a bracing member of an airplane, although the structure 8 may be any of a variety of other structures. The structure 8 includes a first structure surface 88 and a second structure surface 92 opposite one another. The opening 96 extends through the structure 8 between the first and second structure surfaces 88 and 92. The opening 96 thus extends into the structure 8 adjacent the first and second structure surfaces 88 and 92.

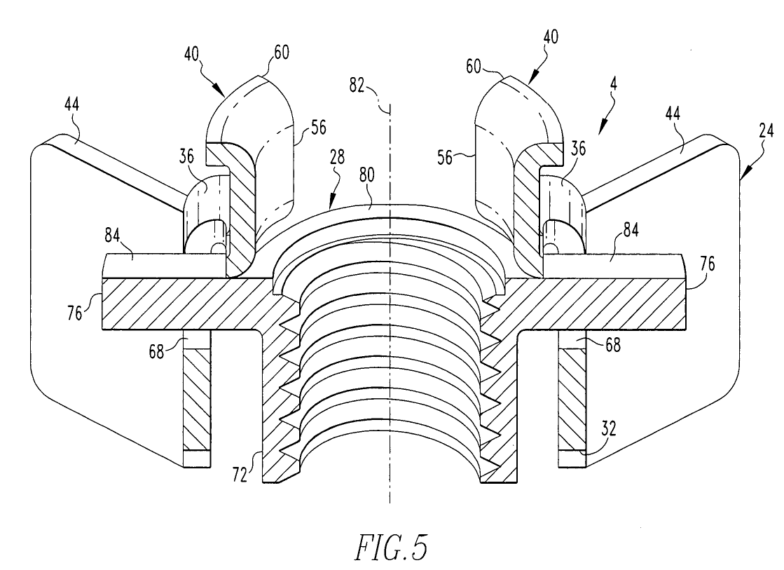

The fastener component 4 is mounted to the structure 8 within the opening 96 by manually grasping the wings 44 and pressing the wings 44 generally toward one another to elastically deflect the support 32 and thus to elastically deflect the lathes 40 toward one another. The support 32 is elastically deflected sufficiently that the lips 60 clear the edges of the opening 96 and permit the latches 40 to be received through the opening in a direction from the second structure surface 92 toward the first structure surface 88 until the lips 60 have passed through the opening 96 and are disposed substantially at the first structure surface 88. The wings 44 are then released, and the support 32 in its elastically deflected condition biases the latches 40 away from one another. Such biasing engages the engagement surfaces 64 of the legs 56 into engagement with the structure 8 within the opening 96. In such condition, the support 32 remains in an elastically deflected condition, which residually biases the legs 56 into engagement with the structure 8 within the opening 96. This is the condition depicted generally in FIGS. 4 and 5.

In such condition, the lips 60 are engageable with the first structure surface 88 to resist movement of the second piece 28 in a direction away from the structure 8. The second piece 28 is moveable with respect to the first piece 24 in a plane which, in the depicted example, is generally parallel with the first and second structure surfaces 88 and 92. However, and as indicated above, the window surfaces 78, which are supported by the lips 60, support the tabs 76 and thus resist movement of the second piece 28 in a direction away from the structure 8. Such planar movability of the second piece 28 with respect to the first piece 24 and thus with respect to the structure 8 accommodates and overcomes the cumulative misplacement that may result when a series of spaced holes such as the opening 96 are formed in the structure 8 and/or the panel 16, thereby facilitating fastenable alignment of the nut 72 with an aperture 98 formed in a liner 94 mounted to a hole formed in the panel 16.

When the panel 16 is disposed on the structure 8 and the screws 12 are sought to be threadably cooperated with the nuts 72, excessive probing with the screw 12 is avoided by the second piece 28 being constrained to move substantially within a plane and to resist movement of the second piece 28 away from the structure 8. The screws 12 thus advantageously need be no longer than required to achieve an appropriate degree of threaded cooperation with the nut 72, and this advantageously saves weight in an aerospace application.

When the screw 12 is tightened with respect to the nut 72, the nut surface 80 and/or the tab surfaces 84 are engaged with the platforms 36 to mount the panel 16 to the structure 8. Even prior to tightening, however, the first piece 24 is structured such that the structure 8 is received between the lips 60 and the platforms 36. The engagement of the engagement surfaces 64 with the structure 8 within the opening 96 resist detachment of the lips 60 from the first structure surface 88.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A fastener component that is structured to be mounted to a structure having an opening formed therein, the structure having a structure surface, the opening extending into the structure adjacent the structure surface, the fastener component comprising:
a first piece having a support and a having pair of latches disposed on the support;
the first piece having a pair of windows formed therein;
the support being elastically deflectable, whereby the latches are elastically deflectable generally toward one another;
a second piece having a nut and a pair of tabs, the tabs protruding outwardly from the nut;
the tabs extending through the windows and being movably disposed therein;
each latch having a leg and a lip;
the legs extending generally away from the support and being structured to extend through the opening formed in the structure; and
the lips protruding from the legs and being structured to be engageable with the structure surface to resist unintended movement of the nut away from the structure.

2. The fastener component of claim 1 wherein the first piece includes a pair of platforms.

3. The fastener component of claim 2 wherein the platforms are disposed on and protrude from the support.

4. The fastener component of claim 3 wherein the legs are disposed on the platforms.

5. The fastener component of claim 4 wherein the legs each include a first end and a second end, the first ends being disposed on the platforms, the lips being disposed generally at the second ends generally opposite the support.

6. The fastener component of claim 5 wherein the lips extend generally away from one another.

7. The fastener component of claim 4 wherein the legs extend in a direction generally away from the platforms.

8. The fastener component of claim 7 wherein the first piece is structured to receive the structure substantially interposed between the pair of platforms and the pair of lips.

9. The fastener component of claim 2 wherein the windows are disposed in the vicinity of the latches.

10. The fastener component of claim 2 wherein the windows are formed in the support adjacent the platforms.

11. The fastener component of claim 10 wherein the platforms are disposed generally between the tabs and the legs.

12. The fastener component of claim 2 wherein the platforms extend from the support generally toward one another.

13. The fastener component of claim 1 wherein the first piece includes an anti-rotation protrusion extending away from the support.

14. The fastener component of claim 13 wherein the anti-rotation protrusion and the legs extend in a common direction generally away from the support.

15. The fastener component of claim 1 wherein the legs are oriented generally parallel with one another.

16. The fastener component of claim 1 wherein each leg includes an engagement surface, the support in an elastically deflected condition being structured to bias the engagement surfaces into engagement with opposed portions of the structure within the opening.

17. The fastener component of claim 1 wherein the first piece includes a pair of wings disposed on the support, one of the wings being disposed adjacent one of the latches, the other of the wings being disposed adjacent the other of the latches, the wings being manually engageable for elastically deflecting the support.

18. The fastener component of claim 17 wherein the support is a generally U-shaped structure having a pair of free ends, the free ends being elastically deflectable generally toward one another, one of the latches and one of the wings being disposed generally at one of the free ends, the other of the latches and the other of the wings being disposed generally at the other of the free ends.

19. The fastener component of claim 1 wherein the support is elastically deflectable from a free state toward an elastically deflected state, the tabs being disposed in the windows when the support is in the free state.

20. The fastener component of claim 19 wherein the support in an elastically deflected condition biases the latches generally away from one another.

21. The fastener component of claim 1 wherein the tabs are disposed in diametrically opposed positions on the nut and extend in opposite radial directions away from the nut.

22. The fastener component of claim 21 wherein the nut has a substantially annular nut surface that is engageable with the platforms.

23. The fastener component of claim 22 wherein the tabs are engageable with the platforms.

24. The fastener component of claim 23 wherein the tabs each include a tab surface, the nut surface and the tab surface being substantially coplanar.

25. The fastener component of claim 24 wherein the tab surface are substantially contiguous with the nut surface.

26. The fastener component of claim 1 wherein the second piece is movable substantially within a plane and wherein movement of the second piece away from the plane is resisted.

27. The fastener component of claim 1 wherein the fastener component is made at least partially of aluminum.
